(19) United States
(12) Patent Application Publication
(10) Pub. No.: US 2024/0178947 A1
(43) Pub. Date: May 30, 2024

(54) METHOD AND APPARATUS FOR PATH SELECTION AND DUPLICATION VIA SIDELINK AND DIRECT LINK

(71) Applicant: INTERDIGITAL PATENT HOLDINGS, INC., Wilmington, DE (US)

(72) Inventors: Oumer Teyeb, Montreal (CA); Martino Freda, Laval (CA); Tuong Hoang, Montreal (CA); Jaya Rao, Montreal (CA); Moon IL Lee, Melville, NY (US)

(73) Assignee: INTERDIGITAL PATENT HOLDINGS, INC., Wilmington, DE (US)

(21) Appl. No.: 18/284,496

(22) PCT Filed: Mar. 30, 2022
(86) PCT No.: PCT/US2022/022533

§ 371 Date: Sep. 27, 2023

Related U.S. Application Data
(60) Provisional application No. 63/168,104, filed on Mar. 30, 2021.

(51) Int. Cl. H04L 1/1867; H04W 40/02

(52) U.S. Cl. CPC H04L 1/189; H04W 40/02

(57) ABSTRACT

Methods and apparatuses for path selection and duplication are described herein. A method performed by a Wireless Transmit/Receive Unit, WTRU, may comprise receiving (1501) configuration information regarding path selection, the configuration information including configured parameters associated with network conditions and/or WTRU conditions. For example, the configured parameters may include a radio threshold, a signal quality threshold, and/or a channel busy ratio/channel occupancy ratio. CBR/CR, threshold. The WTRU may monitor (1502) the current network conditions and/or WTRU conditions. If UL data becomes available (1503) for transmission, the WTRU may determine (1504) one or more paths for transmission based on the configuration information and the current conditions. The one or more paths may comprise a direct path, a sidelink path, both a direct path and a sidelink path, or two sidelink paths.

### CROSS-REFERENCE TO RELATED APPLICATIONS

This application claims the benefit of U.S. Provisional Application No. 63/168,104, filed Mar. 30, 2021, the contents of which are incorporated herein by reference.

### BACKGROUND

Current developments of New Radio (NR) sidelink relays may consider the use of both Wireless Transmit/Receive Unit (WTRU)-to-network relays and WTRU-to-WTRU relays based on PC5 (sidelink). Specifically, based on some study item justifications and/or objectives a first version of NR sidelink may be developed and focus solely on supporting Vehicle-to-Everything (V2X) related road safety services. The design may aim to provide support for broadcast, groupcast and unicast communications in both out-of-coverage and in-network coverage scenarios. On top of that, sidelink-based relaying functionality may additionally be studied in order to achieve sidelink/network coverage extension and power efficiency improvements, considering a wider range of applications and services.

To further explore coverage extensions for sidelink-based communication, a WTRU-to-network coverage extension may be investigated. For example, air interface (Uu) coverage reachability may be necessary for WTRUs to reach servers in Public Data Networks (PDNs) or counterpart WTRUs out of a proximity area. However previous embodiments for WTRU-to-network relays may be limited to Evolved Universal Terrestrial Radio Access (EUTRA)-based technology, and thus may not be applied to NR-based systems, for both Next Generation-Radio Access Network (NG-RAN) and NR-based sidelink communications.

WTRU-to-WTRU coverage extensions may be investigated. Proximity reachability may be limited to single-hop sidelink link, either via EUTRA-based or NR-based sidelink technology. However, that may not be sufficient in the scenario where there is no Uu coverage, considering limited single-hop sidelink coverage.

Overall, sidelink connectivity may be further extended in NR frameworks in order to support enhanced Quality of Service (QOS) requirements.

Single hop NR sidelink relays are currently of interest. For example, mechanism(s) with minimum specification impact may be investigated to support the system aspect (SA) requirements for sidelink-based WTRU-to-network and WTRU-to-WTRU relays, focusing on one or more aspects (if applicable) for layer-3 relay and layer-2 relays. Such aspects may include relay (re-)selection criterion and procedure; relay/remote WTRU authorization; Quality of Service (QOS) for relaying functionality; service continuity; security of relayed connection after SA3 has provided its conclusions; and impacts on user plane protocol stack and control plane procedure, e.g., connection management of relayed connections.

Another objective may be to study mechanism(s) to support upper layer operations of discovery model/procedure for sidelink relaying, assuming no new physical layer channels or signals are used.

It is noted that studies may take into account further input from SA Working Groups (WGs), e.g., SA2 and SA3, for the bullets above (if applicable). It may be assumed that WTRU-to-network relays and WTRU-to-WTRU relays use the same relaying embodiments. It is further noted that forward compatibility for multi-hop relay support in a future release may need to be taken into account. For layer-2 WTRU-to-network relays, the architecture of end-to-end Packet Data Convergence Protocol (PDCP) and hop-by-hop Radio Link Control (RLC), e.g., as may be recommended in 3GPP Technical Reports, may be taken as a starting point.

### SUMMARY

Methods and apparatuses for path selection and duplication are described herein. A method performed by a Wireless Transmit/Receive Unit (WTRU) may comprise receiving configuration information regarding path selection, the configuration information including configured parameters associated with network conditions and/or WTRU conditions. For example, the configured parameters may include a radio threshold, a signal quality threshold, and/or a channel busy ratio/channel occupancy ratio (CBR/CR) threshold. The WTRU may monitor the current network conditions and/or WTRU conditions. If UL data becomes available for transmission, the WTRU may determine one or more paths for transmission based on the configuration information and the current conditions. The one or more paths may comprise a direct path, a sidelink path, both a direct path and a sidelink path, or two sidelink paths.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A, according to an embodiment;

FIG. 1C is a system diagram illustrating an example radio access network (RAN) and an example core network (CN) that may be used within the communications system illustrated in FIG. 1A, according to an embodiment;

FIG. 1D is a system diagram illustrating a further example RAN and a further example CN that may be used within the communications system illustrated in FIG. 1A, according to an embodiment;

FIG. 2 is a diagram illustrating a user plane radio protocol stack for layer 2 evolved WTRU-to-Network relays (PC5), according to an embodiment;

FIG. 3 is a diagram illustrating a control plane radio protocol stack for layer 2 evolved WTRU-to-Network relay (PC5), according to an embodiment;

FIG. 4 is a diagram illustrating a user plane stack for an NR L2 WTRU-to-Network Relay, according to an embodiment;

FIG. 5 is a diagram illustrating a control plane protocol stack for an L2 WTRU-to-Network Relay, according to an embodiment;

FIG. 6 is a diagram illustrating a user plane protocol stack for an L2 WTRU-to-Network Relay, according to an embodiment;

FIG. 7 is a diagram illustrating a control plane protocol stack for an L2 WTRU-to-Network Relay, according to an embodiment;

FIG. 8 is a diagram illustrating a procedure for remote WTRU switching to a direct Uu cell, according to an embodiment;

FIG. 9 is a diagram illustrating a procedure for remote WTRU switching to indirect relay WTRU, according to an embodiment;

FIG. 10 is a diagram illustrating a procedure for remote WTRU connection establishment, according to an embodiment;

FIG. 11 is a diagram illustrating a high level measurement model, according to an embodiment;

FIG. 12A is a diagram illustrating a method for direct Control Plane (CP) connectivity for a remote WTRU, according to an embodiment;

FIG. 12B is a diagram illustrating a method for CP connectivity for a remote WTRU via a relay WTRU, according to an embodiment;

FIG. 12C is a diagram illustrating a method for CP connectivity for a remote WTRU via a direct connection or via a relay WTRU;

FIG. 13 illustrates a scenario in which a relay WTRU may be used as a WTRU to WTRU relay, according to an embodiment;

FIG. 14 illustrates a scenario in which a relay WTRU may be used as a WTRU to NW relay, according to an embodiment; and

FIG. 15 is a flow diagram illustrating a procedure for path selection, according to an embodiment.

### DETAILED DESCRIPTION

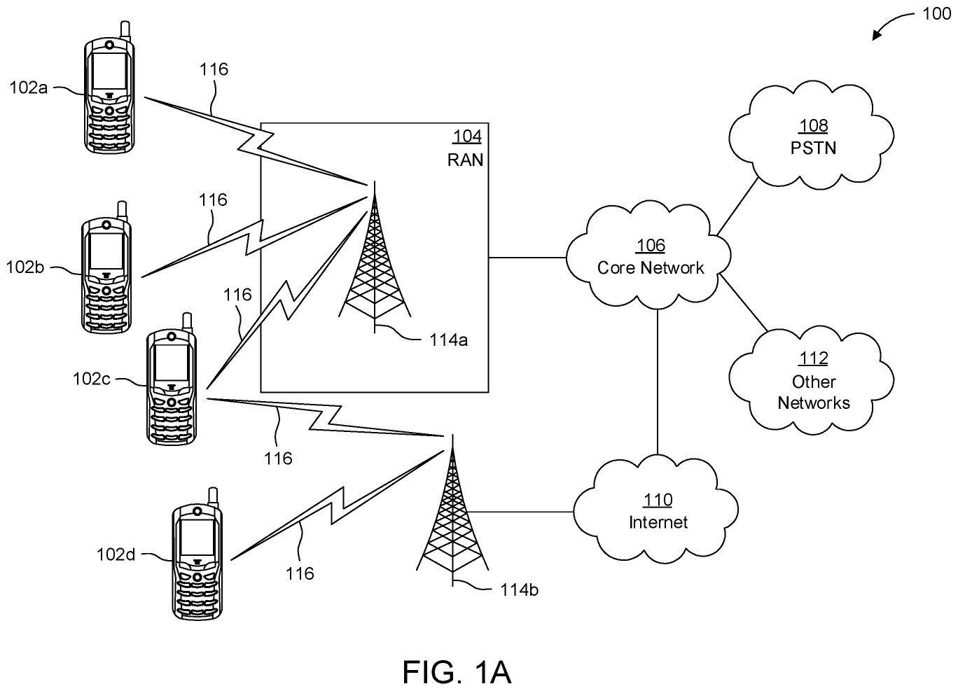

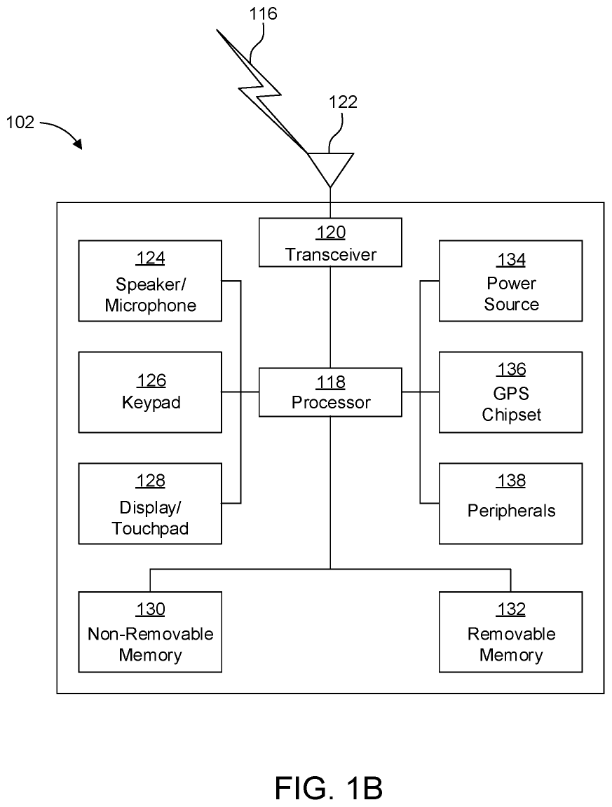

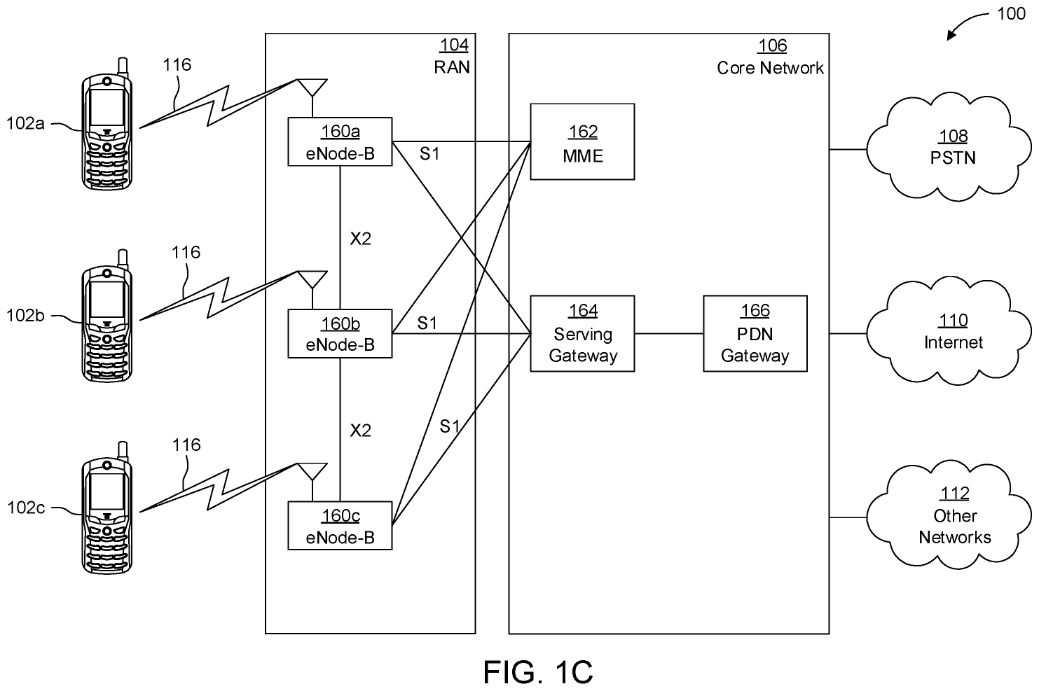

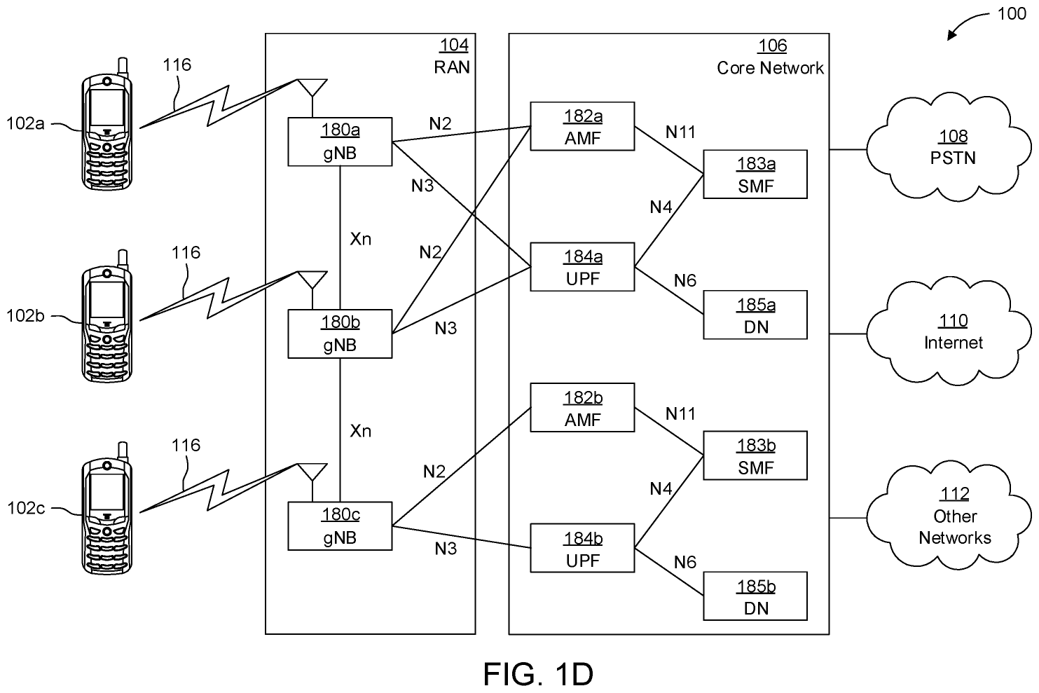

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHZ, and 20 MHz bandwidths in the TV White Space (TVWS) spectrum, and 802.11ah supports 1 MHz, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

WTRU to Network Relays as supported in Long-Term Evolution (LTE) specifications are described herein. Relaying via Proximity-based Services (ProSe) WTRU to Network relays may be supported to extend network coverage to out of coverage WTRUs by using PC5 or Device-to-Device (D2D) interfaces between out of coverage WTRUs and WTRU-to-Network relays.

A ProSe WTRU-to-Network Relay may provide a generic L3 forwarding function (or any logical equivalent) that may relay any type of IP traffic between the Remote WTRU and the network. One-to-one and one-to-many sidelink communications are used between the Remote WTRU(s) and the ProSe WTRU-to-Network Relay. For both Remote WTRU and Relay WTRU one single carrier (i.e., Public Safety ProSe Carrier) operation may be supported (i.e., Uu and PC5 may use the same carrier for Relay/Remote WTRUs). The Remote WTRU may be authorized by upper layers and can be in-coverage of the Public Safety ProSe Carrier or out-of-coverage on any supported carriers including Public Safety ProSe Carrier for WTRU-to-Network Relay discovery, (re)selection and communication. The ProSe WTRU-to-Network Relay may always be in-coverage of a EUTRAN. The ProSe WTRU-to-Network Relay and the Remote WTRU may perform sidelink communication and sidelink discovery.

Relay Selections for WTRU to NW Relays are described herein. Relay selection/reselection for ProSe WTRU to NW relays may be performed based on a combination of AS layer quality measurements (RSRP) and upper layer criteria.

An eNB may control whether a WTRU may act as a ProSe WTRU-to-Network Relay. For example, if the eNB broadcasts any information associated to ProSe WTRU-to-Network Relay operation, then ProSe WTRU-to-Network Relay operation may be supported in the cell.

The eNB may provide transmission resources for ProSe WTRU-to-Network Relay discovery using broadcast signaling for RRC_IDLE state and dedicated signaling for RRC_CONNECTED state and/or reception resources for ProSe WTRU-to-Network Relay discovery using broadcast signaling. The eNB may broadcast a minimum and/or a maximum Uu link quality (RSRP) threshold(s) that the ProSe WTRU-to-Network Relay needs to respect before it can initiate a WTRU-to-Network Relay discovery procedure. In RRC_IDLE, when the eNB broadcasts transmission resource pools, the WTRU may use the threshold(s) to autonomously start or stop the WTRU-to-Network Relay discovery procedure. In RRC_CONNECTED, the WTRU may use the threshold(s) to determine if it can indicate to eNB that it is a Relay WTRU and wants to start ProSe WTRU-to-Network Relay discovery. If the eNB does not broadcast transmission resource pools for ProSe-WTRU-to-Network Relay discovery, then a WTRU may initiate a request for ProSe-WTRU-to-Network Relay discovery resources by dedicated signaling, respecting these broadcasted threshold(s). If the ProSe-WTRU-to-Network Relay is initiated by broadcast signaling, it may perform ProSe WTRU-to-Network Relay discovery when in RRC_IDLE. If the ProSe WTRU-to-Network Relay is initiated by dedicated signaling, it may perform relay discovery as long as it is in RRC_CONNECTED.

A ProSe WTRU-to-Network Relay performing sidelink communication for ProSe WTRU-to-Network Relay operation may need to be in RRC_CONNECTED. After receiving a layer-2 link establishment request (or any logical equivalent) or TMGI monitoring request (upper layer message), as specified in 3GPP specifications, from the Remote WTRU, the ProSe WTRU-to-Network Relay may indicate to the eNB that it is a ProSe WTRU-to-Network Relay and intends to perform ProSe WTRU-to-Network Relay sidelink communication. The eNB may provide resources for ProSe WTRU-to-Network Relay communication.

The remote WTRU may decide when to start monitoring for ProSe WTRU-to-Network Relay discovery. The Remote WTRU may transmit ProSe WTRU-to-Network Relay discovery solicitation messages while in RRC_IDLE or in RRC_CONNECTED depending on the configuration of resources for ProSe WTRU-to-Network Relay discovery. The eNB may broadcast a threshold, which is used by the Remote WTRU to determine if it can transmit ProSe WTRU-to-Network Relay discovery solicitation messages, to connect or communicate with ProSe WTRU-to-Network Relay WTRU. The RRC_CONNECTED Remote WTRU may use the broadcasted threshold to determine if it can indicate to an eNB that it is a Remote WTRU and wants to participate in ProSe WTRU-to-Network Relay discovery and/or communication. The eNB may provide transmission resources using broadcast or dedicated signaling and reception resources using broadcast signaling for ProSe WTRU-to-Network Relay Operation. The Remote WTRU may stop using ProSe WTRU-to-Network Relay discovery and communication resources when RSRP exceeds the broadcasted threshold.

It is noted that the exact time of traffic switching from Uu to PC5 or vice versa may be up to higher layers.

The Remote WTRU may perform radio measurements at a PC5 interface and use them for ProSe WTRU-to-Network Relay selection and reselection along with criteria, as may be specified in 3GPP specifications. A ProSe WTRU-to-Network Relay may be considered suitable in terms of radio criteria if the PC5 link quality exceeds a configured threshold, which may be pre-configured or provided by an eNB. The Remote WTRU may select the ProSe WTRU-to-Network Relay, which may satisfy criterion and have the best PC5 link quality among all suitable ProSe WTRU-to-Network Relays.

The Remote WTRU may trigger ProSe WTRU-to-Network Relay reselection when a PC5 signal strength of a current ProSe WTRU-to-Network Relay is below a configured signal strength threshold or when the Remote WTRU receives a layer-2 link release message from a ProSe WTRU-to-Network Relay, which may be an upper-layer message, as specified in 3GPP specifications or any logical equivalent.

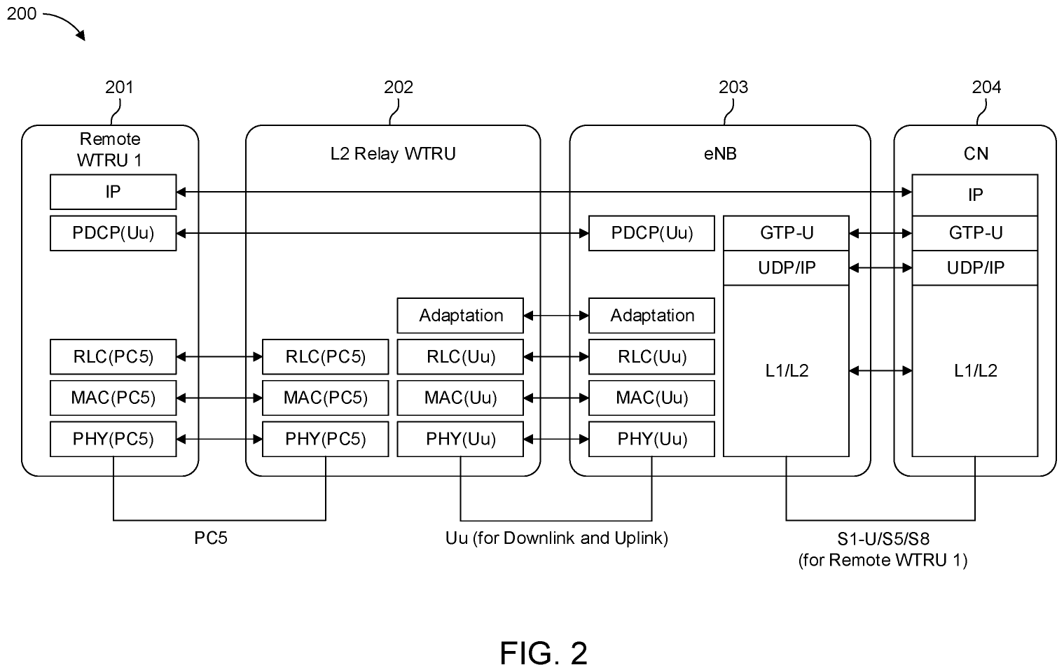

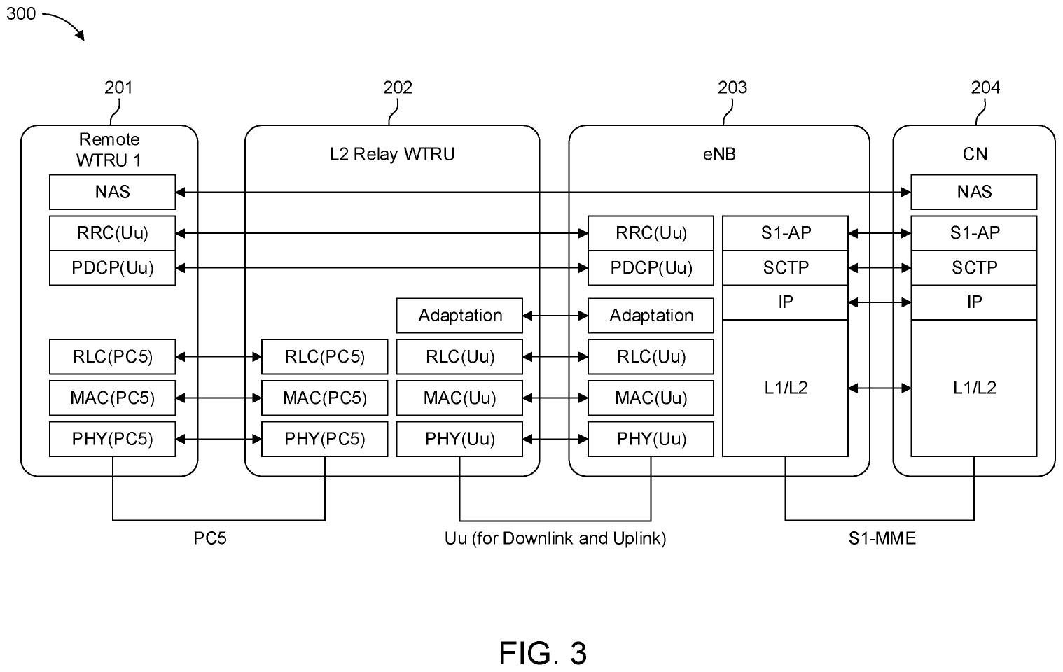

WTRU to Network Relays for Wearables are described herein. Studies of WTRU to NW relays for commercial use cases tailored to wearables and IoT devices have been performed in RAN. In accordance with these studies, some preferred embodiments for such relays may be evident. For example, as opposed to ProSe WTRU to NW relays which may use a L3 (IP layer) relaying approach, or a logically equivalent approach, the WTRU to NW relays for wearables may expected to be a L2 relay (or a logically equivalent relay) based on one or more of the protocol stacks shown in FIGS. 2 and 3.

FIG. 2 is a diagram illustrating a user plane radio protocol architecture for layer 2 evolved WTRU-to-Network relays via PC5 200, according to an embodiment. FIG. 3 is a diagram illustrating a control plane radio protocol architecture for layer 2 evolved WTRU-to-Network relay via PC5 300.

For both the user plane 200 and control plane 300, relaying may be performed above RLC sublayer. Remote WTRU's 201 user plane and control plane data may be relayed above RLC via the WTRU-to-Network Relay WTRU 202 from the remote WTRU 401 to network 404 and vice versa. Uu PDCP and RRC may be terminated between the remote WTRU 201 and the base station (eNB) 203 while RLC, MAC and PHY and the non-3GPP transport layers may be terminated in each link (i.e. the link between the remote WTRU 201 and the relay WTRU 202 and the link between the relay WTRU 202 and the base station 203).

Example procedures for Connection Establishment for Unicast Links in NR V2X are described herein.

Relay solutions for earlier LTE specifications may be based on a one to one communication link established at upper layers (e.g., a ProSe layer, or any logical equivalent) between two WTRUs (e.g., the remote WTRU and WTRU to NW relay). Such connections may be transparent to the AS layer and connection management signaling and procedures performed at the upper layers may be carried by AS layer data channels or logical equivalents. The AS may be therefore be unaware of such a one to one connection.

In NR V2X, the AS layer may support the notion of a unicast link between two WTRUs. Such unicast link may be initiated by upper layers (as in the ProSe one-to-one connection), or a logical equivalent. However, the AS layer, or a logical equivalent, may be informed of the presence of such unicast link, and any data that is transmitted in unicast fashion between the peer WTRUs. With such knowledge, the AS layer or a logical equivalent may support HARQ feedback, CQI feedback, and power control schemes that are specific to unicast.

A unicast link at the AS layer may be supported via a PC5-RRC connection. In accordance with 3GPP specifications, the PC5-RRC connection may be defined as follows. The PC5-RRC connection may be a logical connection between a pair of a Source Layer-2 ID and a Destination Layer-2 ID in the AS. One PC5-RRC connection may correspond to one PC5 unicast link. The PC5-RRC signaling, as specified in 3GPP specifications, may be initiated after its corresponding PC5 unicast link establishment. The PC5-RRC connection and the corresponding sidelink SRBs and sidelink DRBs are released when the PC5 unicast link may be released as indicated by upper layers.

For each PC5-RRC connection of unicast, one sidelink SRB may be used to transmit the PC5-S messages before the PC5-S security has been established. One sidelink SRB may be used to transmit the PC5-S messages to establish the PC5-S security. One sidelink SRB may be used to transmit the PC5-S messages after the PC5-S security has been established, which may be protected. One sidelink SRB may be used to transmit the PC5-RRC signaling, which may be protected and only sent after the PC5-S security has been established.

PC5-RRC signaling may include a sidelink configuration message (RRCReconfigurationSidelink) by which one WTRU configures the RX-related parameters of each SLRB in the peer WTRU. Such reconfiguration message may configure the parameters of each protocol in the L2 stack (SDAP, PDCP, etc). The receiving WTRU may confirm or reject such configuration, depending on whether it can support the configuration suggested by the peer WTRU.

NR sidelink relay, such as layer-2 relays and their logical equivalents, are described herein.

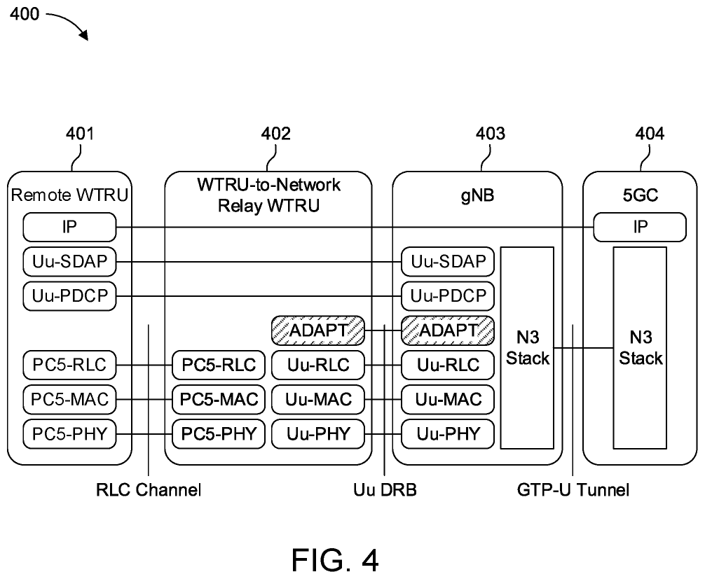

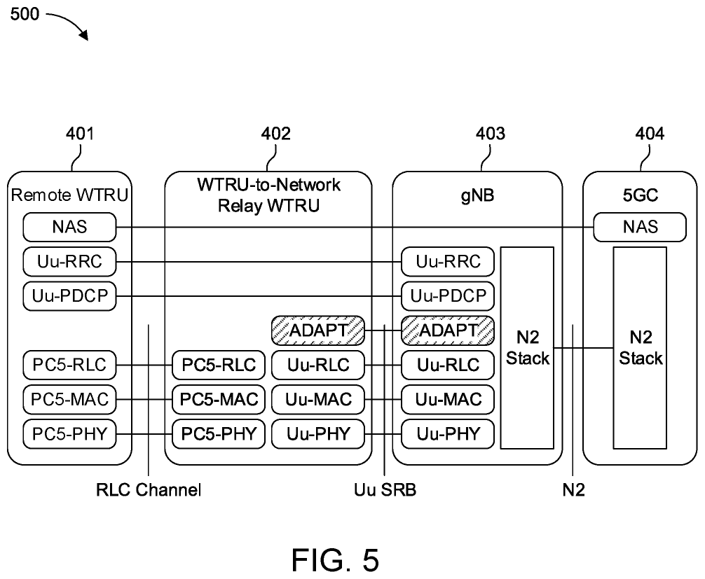

FIG. 4 illustrates a user plane stack for an NR L2 WTRU-to-Network Relay 400. FIG. 5 illustrates a control plane protocol stack for an L2 WTRU-to-Network Relay 500. As shown in FIGS. 4 and 5, there may be may be no adaptation layer at PC5.

For an L2 WTRU-to-Network Relay (or a logical equivalent), the adaptation layer may be placed over RLC sublayer for both CP and UP at the Uu interface between relay WTRU 402 and the base station (gNB) 403. The Uu SDAP/PDCP and RRC may be terminated between the remote WTRU 401 and the base station 403, while RLC, MAC and PHY may be terminated in each link (i.e., the link between remote WTRU 401 and relay WTRU 402 and the link between relay WTRU 402 and the base station 403 connected to network 404). The adaptation layer may also be supported at the PC5 interface between the remote WTRU and the relay WTRU.

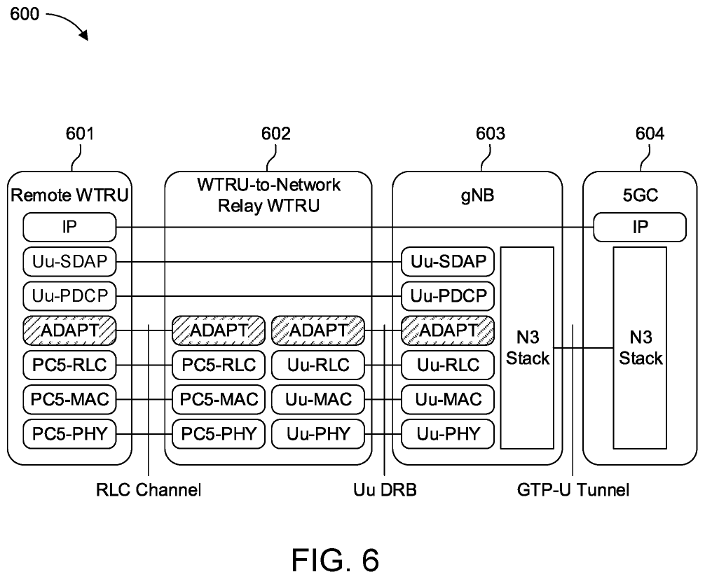

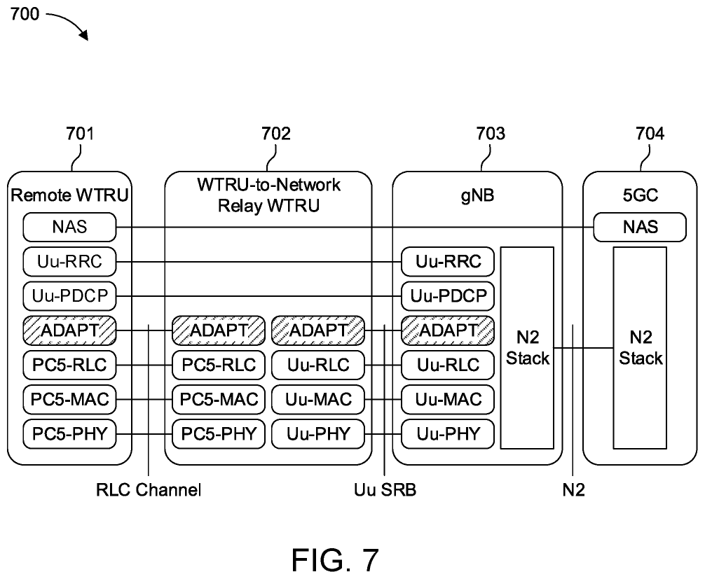

FIG. 6 is a diagram illustrating a user plane protocol stack for an L2 WTRU-to-Network Relay 600. FIG. 7 is a diagram illustrating a control plane protocol stack for an L2 WTRU-to-Network Relay 700. As shown in FIGS. 6 and 7, the adaptation layer may be supported at the PC5 interface.

For an L2 WTRU-to-Network Relay (or a logical equivalent), the adaptation layer may be placed over RLC sublayer for both CP and UP at the Uu interface between relay WTRU 602 and the base station (gNB) 603. The Uu SDAP/PDCP and RRC may be terminated between the remote WTRU 601 and the base station 603, while RLC, MAC and PHY may be terminated in each link (i.e., the link between remote WTRU 601 and relay WTRU 602 and the link between relay WTRU 602 and the base station 603 connected to network 604). The adaptation layer may also be supported at the PC5 interface between the remote WTRU and the relay WTRU.

For an L2 WTRU-to-Network Relay, for uplink, the Uu adaptation layer at the relay WTRU may support UL bearer mapping between ingress PC5 RLC channels for relaying and egress Uu RLC channels over the relay WTRU Uu path. For uplink relaying traffic, the different end-to-end RBs (SRB, DRB) of the same remote WTRU 601 and/or different remote WTRUs can be subject to N:1 mapping and data multiplexing over one Uu RLC channel.

The Uu adaptation layer may be used to support remote WTRU identification for the UL traffic (multiplexing the data coming from multiple remote WTRU). The identity information of a Remote WTRU Uu Radio Bearer and Remote WTRU may be included in the Uu adaptation layer at UL in order for base station to correlate the received data packets for the specific PDCP entity associated with the right Remote WTRU Uu Radio Bearer of a Remote WTRU.

For L2 WTRU-to-Network Relay, for downlink, the Uu adaptation layer may be used to support DL bearer mapping at a base station to map end-to-end Radio Bearer (SRB, DRB) of the Remote WTRU into Uu RLC channel over a Relay WTRU Uu path. The Uu adaptation layer may be used to support DL N:1 bearer mapping and data multiplexing between multiple end-to-end Radio Bearers (SRBs, DRBs) of a Remote WTRU and/or different Remote WTRUs and one Uu RLC channel over the Relay WTRU Uu path.

The Uu adaptation layer may need to support Remote WTRU identification for Downlink traffic. The identity information of a Remote WTRU Uu Radio Bearer and the identity information of a Remote WTRU may need to be put into the Uu adaptation layer by a base station at DL in order for Relay WTRU to map the received data packets from Remote WTRU Uu Radio Bearer to its associated PC5 RLC channel.

A base station implementation may handle the QoS breakdown over Uu and PC5 for the end-to-end QoS enforcement of a particular session established between Remote WTRU and network in case of L2 WTRU-to-Network Relay. Details of handling in the case PC5 RLC channels with different end-to-end QoS are mapped to the same Uu RLC channel may be further considered.

Various aspects of service continuity are described herein. An L2 WTRU-to-Network Relay may be the RAN2 principle of the NR handover procedure as the baseline AS layer solution to guarantee service continuity (i.e., a base station may hand over the remote WTRU to a target cell or target relay WTRU). The procedure may include (1) Handover preparation type of procedure between a base station and a relay WTRU (if needed); (2) a RRCReconfiguration to a remote WTRU, remote WTRU switching to the target, and (3) a handover complete message, similar to legacy procedures.

The exact content of the messages (e.g., handover command) may vary. Inter-node messages may or may not be sent over Uu.

Various aspects of switching from indirect to direct paths are described herein. For service continuity of L2 WTRU-to-Network relays, a baseline procedure as described in the following described figures and paragraphs may be used, in the case of remote WTRU switching to a direct Uu cell.

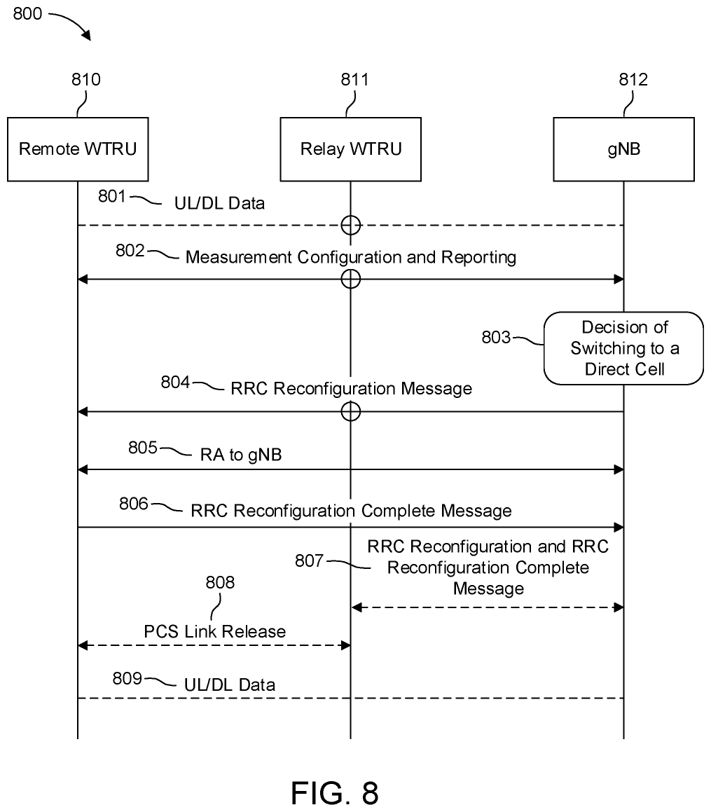

FIG. 8 illustrates a procedure 800 for a remote WTRU switching to a direct Uu cell, according to an embodiment. At 801, UL and DL data may be communicated between remote WTRU 810 and gNB 812. At 802, the remote WTRU 810 may report one or multiple candidate relay WTRU(s), after remote WTRU measures/discoveries. The remote WTRU 810 may filter the appropriate relay WTRU(s) meeting higher layer criteria when reporting. The reporting may include the relay WTRU's ID and SL RSRP information, where the details of the measurements on PC5 are FFS. At 803, the gNB 812 may decide to switch to a direct cell. At 803, an RRC Reconfiguration message may be sent to remote WTRU 810. At 805, remote WTRU 810 may perform Random Access to the gNB 812. At 806, the remote WTRU 810 may send feedback via a RRCReconfigurationComplete message to the gNB 812 over a target path, using the target configuration provided in the RRC Reconfiguration message. At 807, the RRC Reconfiguration may be communicated to the relay WTRU 811. At 808, the PC5 link may be released between the remote WTRU 810 and the relay WTRU 811, if needed. At 809, the data path may be switched. It is noted that 807, 808, and 809 may be performed in any order.

Additional aspects of procedure 800 may be further considered. For example, it may be determined whether a Remote WTRU suspends data transmission via relay link after receiving the RRC reconfiguration message 804. It may be determined whether the RRC reconfiguration message may be communicated to the relay WTRU 811 at 807 before or after the remote WTRU 810 receiving the RRC reconfiguration message 804 and its necessity. It may be determined whether PC5 link release 808 may be performed after the remote WTRU 810 receives RRC reconfiguration message at 804 or after the remote WTRU 810 transmits the RRC reconfiguration complete message at 806, and its necessity, i.e., whether it may be replaced by PC5 reconfiguration. It may be determined whether switching that data path at 809 may be performed after the remote WTRU 810 transmits the RRC reconfiguration complete message at 806.

Various aspects of switching from direct to indirect path are described herein. For service continuity of L2 U2N relay, a baseline procedure as described in the following described figures and paragraphs may be performed, for instance in the case of remote WTRU switching to indirect relay WTRU.

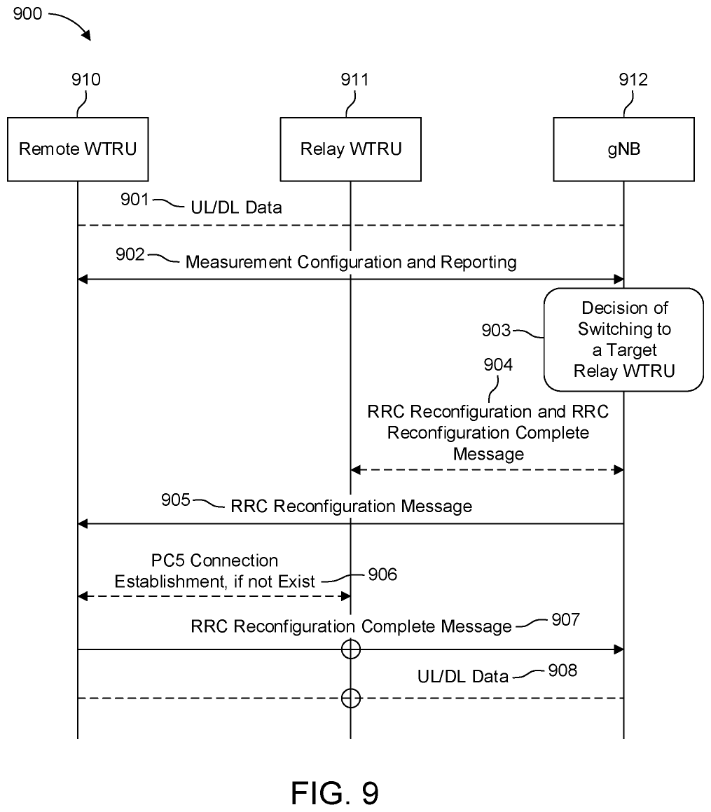

FIG. 9 illustrates a procedure 900 for remote WTRU switching to indirect relay WTRU, according to an embodiment. AT 901, UL/DL data may be communicated between remote WTRU 910 and gNB 912. At 902, remote WTRU 910 may report one or multiple candidate relay WTRU(s), after remote WTRU measures/discoveries the candidate relay WTRU(s). At 902, the remote WTRU 910 may filter the appropriate relay WTRU(s) meeting higher layer criteria when reporting. In some embodiments, the reporting may include the relay WTRU's ID and SL RSRP information, where the details of the measurements on PC5 are FFS. At 903, the gNB 912 may make the decision to switch to a target relay WTRU by base station. In some embodiments, target configuration or reconfiguration (e.g., preparation) may optionally be sent to relay WTRU 911. At 904, the RRC Reconfiguration may be communicated to the relay WTRU 911. At 905, the RRC Reconfiguration message may be communicated to the remote WTRU 910. In some embodiments, an identity of the target relay WTRU, and/or a Target Uu and PC5 configuration may be included. At 906, remote WTRU 910 may establish a PC5 connection with a target relay WTRU 911, if the connection has not been setup yet. At 907, remote WTRU 910 may feedback the RRCReconfigurationComplete to the gNB 912 via a target path, using the target configuration provided in RRCReconfiguration. At 908, the data path may be switched.

In some embodiments it may be further considered whether the decision of switching to a target WTRU at 903 may be performed after the relay WTRU connects to the base station (e.g., after 906), if not yet before. It may be further considered whether PC5 connection establishment at 906 may be performed before steps 903 and/or 905.

Various aspects of connection management are described herein. A remote WTRU may need to establish its own PDU sessions/DRBs with the network before user plane data transmission.

PC5-RRC aspects of NR V2X PC5 unicast link establishment procedures may be reused to setup a secure unicast link between Remote WTRU and Relay WTRU for L2 WTRU-to-Network relaying before Remote WTRU establishes a Uu RRC connection with the network via Relay WTRU.

For both in-coverage and out-of-coverage cases, when a remote WTRU initiates the first RRC message for its connection establishment with base station, the PC5 L2 configuration for the transmission between the remote WTRU and the WTRU-to-Network Relay WTRU may be based on the RLC/MAC configuration defined in specifications.

The establishment of Uu SRB1/SRB2 and DRB of the Remote WTRU may be subject to legacy Uu configuration procedures for the L2 WTRU-to-Network Relay.

High level connection establishment procedures as described herein may be applied to L2 WTRU-to-Network Relay.

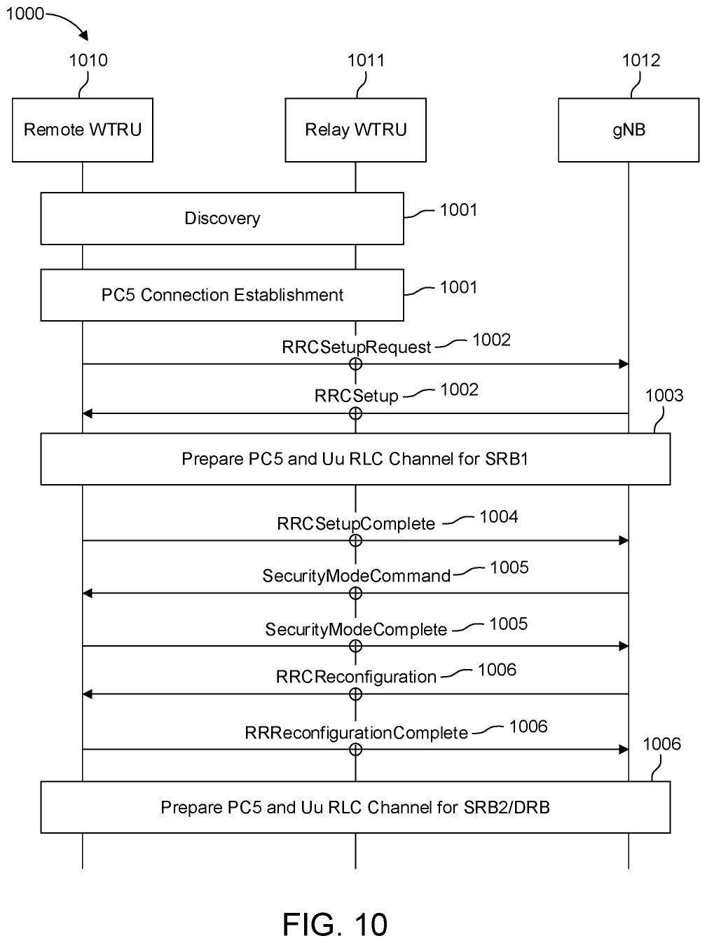

FIG. 10 illustrates a procedure 1000 for remote WTRU connection establishment, according to an embodiment. At 1001, remote WTRU 1010 and relay WTRU 1011 may perform a discovery procedure and establish PC5-RRC connection using legacy procedures as a baseline. At 1002, remote WTRU 1010 may send the first RRC message (i.e., RRCSetupRequest) for its connection establishment with the gNB 1012 via the relay WTRU 1011, using a default L2 configuration on PC5. The gNB 1012 may respond with an RRCSetup message to remote WTRU 1010. The RRCSetup delivery to the Remote WTRU may use the default configuration on PC5. If the relay WTRU 1011 had not started in RRC_CONNECTED, it may need to perform its own connection establishment as part of 1002. Details for the relay WTRU 1011 to forward the RRCSetupRequest/RRCSetup message for remote WTRU 1010 may be further considered. At 1003, the gNB 1012 and relay WTRU 1011 may perform a relaying channel setup procedure over Uu. According to the configuration from the gNB 1012, the relay WTRU 1011 and remote WTRU 1010 may establish an RLC channel for relaying of SRB1 towards the remote WTRU 1010 over PC5. This step may prepare the relaying channel for SRB1. At 1004, a remote WTRU SRB1 message (e.g., an RRCSetupComplete message) may be sent to the gNB 1012 via the relay WTRU 1011 using SRB1 relaying channel over PC5. The remote WTRU 1010 may then be RRC connected over Uu. At 1005, the remote WTRU 1010 and gNB 1012 may establish security following a legacy procedure, and the security messages may be forwarded through the relay WTRU 1011. At 1006, the gNB 1012 may set up additional RLC channels between the gNB 1012 and relay WTRU 1011 for traffic relaying. According to the configuration from base station, the relay WTRU 1011 and remote WTRU 1010 may set up additional RLC channels between the remote WTRU 1010 and relay WTRU 1011 for traffic relaying. The gNB 1012 may send an RRCReconfiguration to the remote WTRU 1010 via the relay WTRU 1011, to set up the relaying SRB2/DRBs. The remote WTRU 1010 may send an RRCReconfigurationComplete to the gNB 1012 via the relay WTRU 1011 as a response.

Besides the connection establishment procedure, for L2 WTRU-to-Network relay, the RRC reconfiguration and RRC connection release procedures may reuse legacy RRC procedures, with the message content/configuration design to be further considered.

The RRC connection re-establishment and RRC connection resume procedures may reuse the legacy RRC procedure as baseline, by considering the above connection establishment procedure of L2 WTRU-to-Network Relay to handle the relay specific part, with the message content/configuration design left to be further considered.

Measurements in NR, including over an air interface, are described herein. In RRC_CONNECTED, the WTRU may measure a plurality of beams of a cell. The measurements results (i.e., power values) may be averaged to derive the cell quality. The WTRU may be configured to consider a subset of the plurality of beams. Filtering may take place at two different levels: (1) at the physical layer to derive beam quality and (2) at the RRC level to derive cell quality from multiple beams. Cell quality from beam measurements may be derived in the same way for serving cell(s) and for non-serving cell(s). Measurement reports may contain the measurement results of the subset of the plurality of beams.

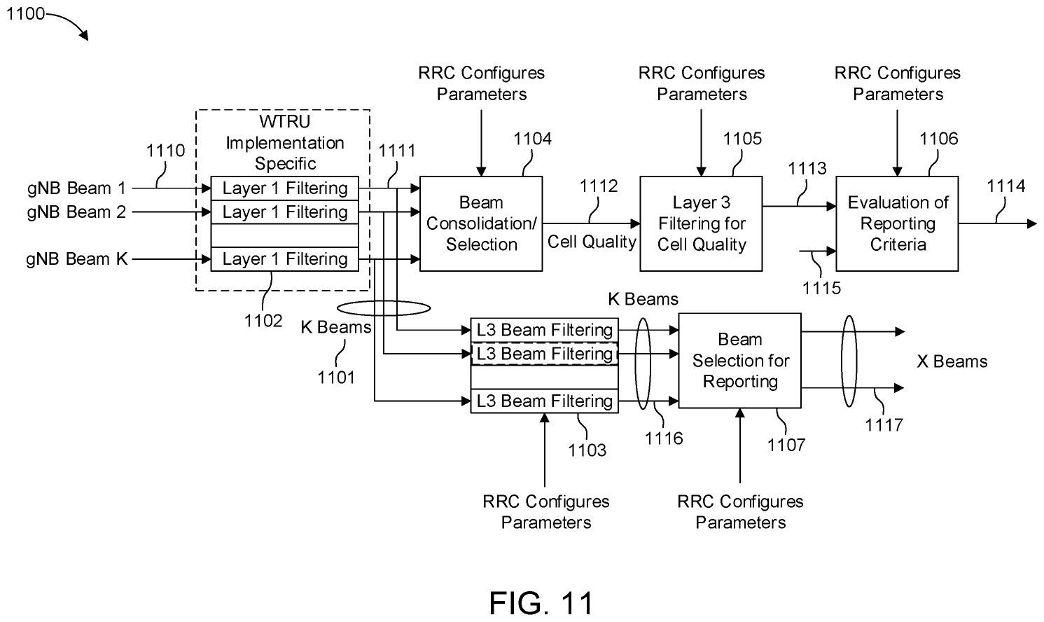

FIG. 11 is a diagram of a high level measurement model 1100, according to an embodiment. It is noted that the number of K beams 1101 may correspond to the measurements on SSB or CSI-RS resources configured for L3 mobility by a base station and detected by a WTRU at L1, or via logically equivalent signaling. In FIG. 11, at 1110, measurements (i.e., beam specific samples) internal to the physical layer or other logical equivalents, may be performed. Layer 1 filtering 1102, i.e., internal layer 1 filtering of the inputs 1110 measured may be performed. Exact filtering is implementation dependent. How the measurements are actually executed in the physical layer by an implementation (inputs 1110 and Layer 1 filtering 1102) may not be constrained by the 3GPP specifications.

In FIG. 11, measurements (i.e., beam specific measurements) may be reported at 1111. In some embodiments, the measurements may be reported by layer 1 to layer 3 after layer 1 filtering. At 1104, beam consolidation/selection may be performed. For example, in some embodiments, beam specific measurements may be consolidated to derive cell quality. The behavior of the beam consolidation/selection may be standardized and the configuration of this module may be provided by RRC signaling. A reporting period at 1112 may equal one measurement period at 1111.

In FIG. 11, at 1112, a measurement (i.e., cell quality) derived from beam-specific measurements may be reported to layer 3. After beam consolidation/selection 1104, layer 3 filtering for cell quality 1105 may be performed. For example, filtering may be performed on the measurements provided at 1112. The behavior of the Layer 3 filters may be standardized and the configuration of the layer 3 filters may be provided by RRC signaling. Filtering reporting period at 1113 may equal one measurement period at 1112.

In FIG. 11, at 1113, a measurement may be performed after processing in the layer 3 filter. The reporting rate may be identical to the reporting rate at point 1112. This measurement may be used as input for one or more evaluation of reporting criteria and evaluation of reporting criteria 1006 may be performed. For example, it may be checked whether actual measurement reporting is necessary at point 1114. The evaluation may be based on more than one flow of measurements at reference point 1113, e.g., to compare between different measurements. This is illustrated by input 1113 and 1115. The WTRU may evaluate the reporting criteria at least every time a new measurement result is reported at point 1113 and 1115. The reporting criteria may be standardized and the configuration may be provided by RRC signaling (WTRU measurements).

In FIG. 11, at 1114, measurement report information (message) may be sent on the radio interface. L3 Beam filtering 1103 may be performed. For example, filtering may be performed on the measurements (i.e., beam specific measurements) provided at point 1111. The behavior of the beam filters may be standardized and the configuration of the beam filters may be provided by RRC signaling. Filtering reporting period at 1116 may equal one measurement period at 1111.

In FIG. 11, at 1116, a measurement (i.e., beam-specific measurement) may be performed after processing in the beam filter. The reporting rate may be identical to the reporting rate at point 1111. This measurement may be used as an input for selecting the X measurements to be reported. Beam Selection for beam reporting 1107 may be performed. For example, X measurements from the measurements provided at point 1116 may be selected. The behavior of the beam selection may be standardized and the configuration of this module may be provided by RRC signaling.

In FIG. 11, at 1117, beam measurement information may be included in a measurement report (sent) on the radio interface.

Layer 1 filtering may introduce a certain level of measurement averaging. How and when the WTRU exactly performs the required measurements is implementation specific to the point that the output at 1112 fulfils the performance requirements set in 3GPP specifications. Layer 3 filtering for cell quality and related parameters used may be specified in the 3GPP specifications and not introduce any delay in the sample availability between 1112 and 1113. Measurements at point 1113 and/or 1115 may be the input used in the event evaluation. L3 Beam filtering 1103 and related parameters used may be specified in the 3GPP specifications and not introduce any delay in the sample availability between 1116 and 1117.

Measurement reports are characterized as follows. For example, measurement reports may include the measurement identity of the associated measurement configuration that triggered the reporting. Cell and beam measurement quantities to be included in measurement reports may be configured by the network. The number of non-serving cells to be reported may be limited through configuration by the network. Cells belonging to a blacklist configured by the network may not be used in event evaluation and reporting, and conversely, when a whitelist is configured by the network, only the cells belonging to the whitelist may be used in event evaluation and reporting. Beam measurements to be included in measurement reports may be configured by the network (e.g., a beam identifier only, measurement result and beam identifier, or no beam reporting).

Intra-frequency neighbor (cell) measurements and inter-frequency neighbor (cell) measurements are defined as follows. A measurement may be defined as an SSB based intra-frequency measurement provided the center frequency of the SSB of the serving cell and the center frequency of the SSB of the neighbor cell are the same, and the subcarrier spacing of the two SSBs is also the same. A measurement may be defined as an SSB based inter-frequency measurement provided the center frequency of the SSB of the serving cell and the center frequency of the SSB of the neighbor cell are different, or the subcarrier spacing of the two SSBs is different. It is noted that for SSB based measurements, one measurement object corresponds to one SSB and the WTRU considers different SSBs as different cells.

A measurement may be defined as a CSI-RS based intra-frequency measurement provided that: the SCS of CSI-RS resources on the neighbor cell configured for measurement is the same as the SCS of CSI-RS resources on the serving cell indicated for measurement; for SCS=60 kHz, the CP type of CSI-RS resources on the neighbor cell configured for measurement is the same as the CP type of CSI-RS resources on the serving cell indicated for measurement; and the center frequency of CSI-RS resources on the neighbor cell configured for measurement is the same as the center frequency of CSI-RS resource on the serving cell indicated for measurement.

A measurement may be defined as a CSI-RS based inter-frequency measurement if it is not a CSI-RS based intra-frequency measurement. It is noted that an extended CP for CSI-RS based measurement may not be supported.

Whether a measurement is non-gap-assisted or gap-assisted may be on the capability of the WTRU, the active BWP of the WTRU and the current operating frequency. For SSB based inter-frequency measurements, if the measurement gap requirement information is reported by the WTRU, a measurement gap configuration may be provided according to the information. Otherwise, a measurement gap configuration may always be provided in the following cases: for example, if the WTRU only supports per-WTRU measurement gaps, or if the WTRU supports per-FR measurement gaps and any of the serving cells are in the same frequency range of the measurement object.

For SSB based intra-frequency measurement, if the measurement gap requirement information is reported by the WTRU, a measurement gap configuration may be provided according to the information. Otherwise, a measurement gap configuration is always provided if, other than the initial BWP, any of the WTRU configured BWPs do not contain the frequency domain resources of the SSB associated to the initial DL BWP.

The measurement reporting configuration may be either event triggered or periodical. If it is periodical, the WTRU may send the measurement report every reporting interval. In some embodiments, the reporting interval can range between 120 ms and 30 minutes.

For event triggered measurements, the WTRU may send the measurement report when the conditions associated with the event are fulfilled. A WTRU may keep on measuring serving cell and neighbors report quantity and validate it with the threshold or offset defined in report configuration. The report quantity/the trigger for event may be RSRP, RSRQ or SINR.

The following measurement events may be defined for NR implementations. Intra-RAT events may include an Event A1 (e.g., when serving becomes better than a threshold). This may be used to cancel an ongoing handover procedure. This may be required if a WTRU moves towards cell edge and triggers a mobility procedure, but then subsequently moves back into good coverage before the mobility procedure has completed.

Another event is Event A2 (e.g., when serving becomes worse than a threshold). Since it may not involve any neighbor cell measurements, A2 may be used to trigger a blind mobility procedure, or the network may configure the WTRU for neighbor cell measurements when it receives a measurement report that is triggered due to event A2 in order to save WTRU battery (i.e., not perform neighbor cell measurement when the serving cell quality is good enough).

Another event is Event A3 (e.g., when a neighbor becomes offset better than special cell (SpCell)). Event A3 may be used for handover procedure. Note that an Spcell may be the primary serving cell of either the Master Cell Group (MCG) (i.e., the Primary Cell (PCell)) or Secondary Cell Group (SCG) (i.e., the PSCell). Thus, in Dual-Connectivity operation, the Secondary Node (SN) may configure an A3 event for SN triggered PSCell change.

Another event is Event A4 (e.g., when a Neighbor becomes better than a threshold). This may be used for handover procedures that do not depend upon the coverage of the serving cell (e.g., load balancing, where the WTRU is handed over to a good neighbor cell even if the serving cell conditions are excellent).

Another event is Event A5 (e.g., when an SpCell becomes worse than threshold1 and neighbor becomes better than a threshold2). Like A3, this may be used for handover, but unlike A3, it provides a handover triggering mechanism based upon absolute measurements of the serving and neighbor cell, while A3 uses relative comparison. As such, it is suitable for time critical handover when the serving cell becomes weak and it is necessary to change towards another cell which may not satisfy the criteria for an event A3 handover.

Another event is Event A6 (e.g., when a Neighbor becomes offset better than an SCell). This may be used for SCell addition/releasing.

Inter-RAT events are described herein. An Event B1 (e.g., when an Inter-RAT neighbor becomes better than threshold) may be equivalent to A4, but for the case of inter-RAT handover. An Event B2 (e.g., when a PCell becomes worse than a threshold1 and an inter-RAT neighbor becomes better than a threshold2) may be equivalent to A5, but for the case of inter-RAT handover.

The WTRU's measurement configuration may contain an s-measure configuration (s-MeasureConfig), which may specify a threshold for NR SpCell RSRP measurement controlling when the WTRU is required to perform measurements on non-serving cells. The value may be a threshold corresponding to ssb-RSRP (corresponding to cell RSRP based on SS/PBCH block) or a choice of CSI-RSRP (corresponding to cell RSRP of CSI-RS). If the measured SpCell SSB or CSI RSRP is above the threshold, the WTRU may not perform measurements on non-serving cells, improving WTRU power consumption (i.e., the WTRU does not perform unnecessary measurements if it has very good radio conditions towards the serving cells).

Measurements on sidelink are described herein. Various aspects of Power Control related to sidelink measurements are described herein. For in-coverage operation, the power spectral density of sidelink transmissions may be adjusted based on the pathloss from the base station. For unicast, the power spectral density of some sidelink transmissions may be adjusted based on the pathloss between the two communicating WTRUs.

Various aspects of CSI reporting related to sidelink measurements are described herein. For unicast, channel state information reference signal (CSI-RS) may be supported for CSI measurement and reporting in sidelink. A CSI report may be carried in a sidelink MAC CE.

An example of a physical layer measurement definition is provided herein. For measurements on the sidelink, the following WTRU measurement quantities may be supported: PSBCH reference signal received power (PSBCH RSRP); PSSCH reference signal received power (PSSCH-RSRP); PSCCH reference signal received power (PSCCH-RSRP); sidelink received signal strength indicator (SL RSSI); sidelink channel occupancy ratio (SL CR); and sidelink channel busy ratio (SL CBR).

Various aspects of sidelink measurement configuration and reporting are described herein. The WTRU may configure the associated peer WTRU to perform NR sidelink measurement and report on the corresponding PC5-RRC connection in accordance with the NR sidelink measurement configuration for unicast by RRCReconfigurationSidelink message.

The NR sidelink measurement configuration may include one or more parameters for a PC5-RRC connection. For example, the NR sidelink measurement configuration may include NR sidelink measurement objects. These may be object(s) on which the associated peer WTRU may perform the NR sidelink measurements. For NR sidelink measurements, an NR sidelink measurement object may indicate the NR sidelink frequency of reference signals to be measured.

The NR sidelink measurement configuration may include NR sidelink reporting configurations. There may be one or multiple NR sidelink reporting configurations per NR sidelink measurement object. Each NR sidelink reporting configuration may include one or more information or parameters. For example, each sidelink reporting configuration may include reporting criterion, which may be criterion that triggers the WTRU to send a NR sidelink measurement report. This may either be periodical or a single event description. Each sidelink reporting configuration may include each RS type, which may be the RS that the WTRU uses for NR sidelink measurement results. DMRS may be supported for NR sidelink measurements. Each sidelink reporting configuration may include a reporting format, which may be the quantities that the WTRU includes in the measurement report. RSRP measurements are supported.

The NR sidelink measurement configuration may include NR sidelink measurement identities. These may be a list of NR sidelink measurement identities where each NR sidelink measurement identity links one NR sidelink measurement object with one NR sidelink reporting configuration. By configuring multiple NR sidelink measurement identities, it may be possible to link more than one NR sidelink measurement object to the same NR sidelink reporting configuration, as well as to link more than one NR sidelink reporting configuration to the same NR sidelink measurement object. The NR sidelink measurement identity may also be included in the NR sidelink measurement report that triggered the reporting, serving as a reference to the network.

The NR sidelink measurement configuration may include NR sidelink quantity configurations. The NR sidelink quantity configuration may define the NR sidelink measurement filtering configuration used for all event evaluation and related reporting, and for periodical reporting of that NR sidelink measurement. In each configuration, different filter coefficients may be configured for different NR sidelink measurement quantities.

Both WTRUs of the PC5-RRC connection may maintain an NR sidelink measurement object list, an NR sidelink reporting configuration list, and a NR sidelink measurement identities list according to signaling and procedures described herein.

A WTRU may derive NR sidelink measurement results by measuring one or multiple DMRS associated per PC5-RRC connection as configured by the peer WTRU associated. For all NR sidelink measurement results the WTRU may apply the layer 3 filtering before using the measured results for evaluation of reporting criteria and measurement reporting. In some embodiments, only NR sidelink RSRP may be configured as a trigger quantity and reporting quantity.

The following measurement events may be defined for NR sidelink: Event S1 (e.g., when serving becomes better than threshold) and Event S2 (e.g., when Serving becomes worse than threshold). The S1 and S2 based measurement (reports) may be used by the WTRU receiving the reports to adjust the power level when transmitting data.

NR sidelink transmissions may have the following two modes of resource allocations: Mode 1, in which sidelink resources are scheduled by a base station, and Mode 2, in which the WTRU autonomously selects sidelink resources from a configured or pre-configured sidelink resource pool or pools based on the channel sensing mechanism. For the in-coverage WTRU, WTRUs may be configured to operate in Mode 1 or Mode 2. For the out-of-coverage WTRU, Mode 2 may be adopted.

To enhance QoS of NR sidelink transmissions, congestion control may be important to prevent a transmitting WTRU from occupying too many resources in sidelink transmissions. Congestion control may be particularly important in Mode 2. Two metrices may be defined for this purpose: the Channel Busy Ratio (CBR) and the Channel Occupation Ratio (CR). The CBR may be defined as the portion of subchannels whose RSSI exceeds a preconfigured value over a certain time duration. Considering a particular slot n, the CR may be defined as (X+Y)M, where X is the number of the subchannels that have been occupied by a transmitting WTRU within [n−a, n−1], Y is the number of the subchannels that have been granted within [n, n+b], and M is the total number of subchannels within [n−a, n+b].

For congestion control, an upper bound of CR denoted by CRlimit may be imposed to a transmitting WTRU, where CRlimit is a function of CBR and the priority of the sidelink transmissions. The amount of resources occupied by a transmitting WTRU may not exceed CRlimit.

The CBR report may also be used by the base station to determine the pool of resources allocated to sidelink communication (e.g., increase the pool of resources if the WTRUs involved in sidelink communication are reporting high CBRs, decrease the pool of resources if the CBRs reported are low, etc.).

In addition to peer WTRUs involved in sidelink operation configuring each other for measurement (either periodical or S1/S2 events), for in coverage operation (i.e., when the remote WTRU is within the coverage of the base station), the base station may configure the remote WTRU with CBR measurements, which may also be either periodical or event triggered. The following two measurement events may be configured for CBR measurement reporting: Event C1 (i.e., when CBR of NR sidelink communication becomes better than absolute threshold) and/or Event C2 (i.e., when CBR of NR sidelink communication becomes worse than absolute threshold).

Problems related to Control Plane (CP) connectivity for remote WTRUs are described herein.

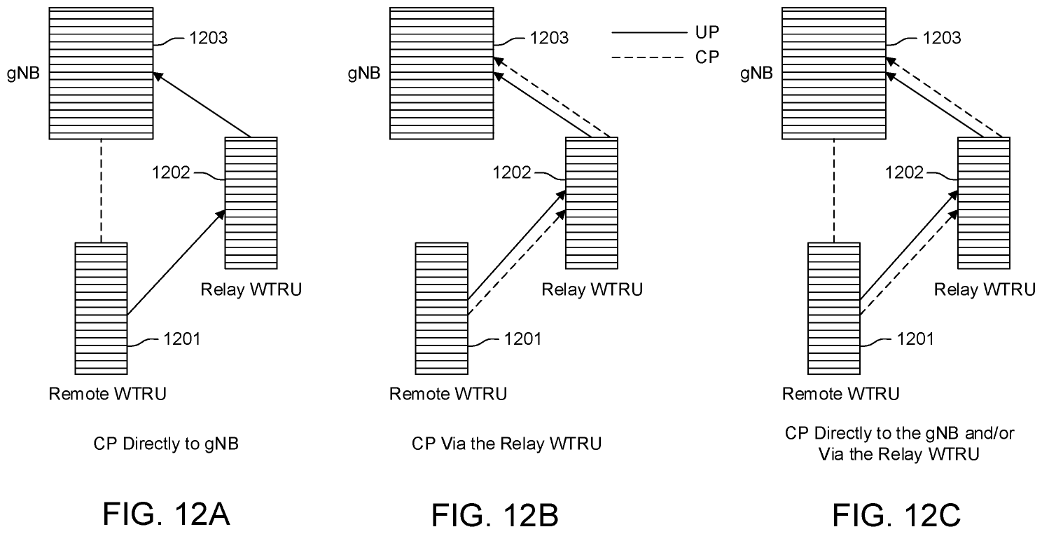

FIGS. 12A-12C illustrate different methods for CP connectivity for a remote WTRU. In the embodiments illustrated in FIGS. 12A-12C, it is assumed that the User Plane (UP) is always transmitted via the relay WTRU.

In the embodiment illustrated in FIG. 12A, CP is directly connected to the base station (gNB) 1203. Although this may be the most straightforward option, it may be applicable only for in coverage (IC) WTRU, and may not be reliable when the radio conditions over the direct link to the base station are insufficient.

In the embodiment illustrated in FIG. 12B, the CP is connected to the base station (gNB) 1203 via relay WTRU 1202. This may be an option for an out of coverage (OOC) WTRU. However, for an IC WTRU, extra latency may be incurred and overall more network resource may need to be utilized.

In the embodiment illustrated in FIG. 12C, CP signaling may use the direct or relayed link. In this embodiment, the remote WTRU 1201 may use one or both of the links on an as-needed basis.

Considered herein are methods for determining the optimal path or paths for the transmission of UL signaling of the remote WTRU. Example methods for enhanced control plane signal routing may be described as follows.

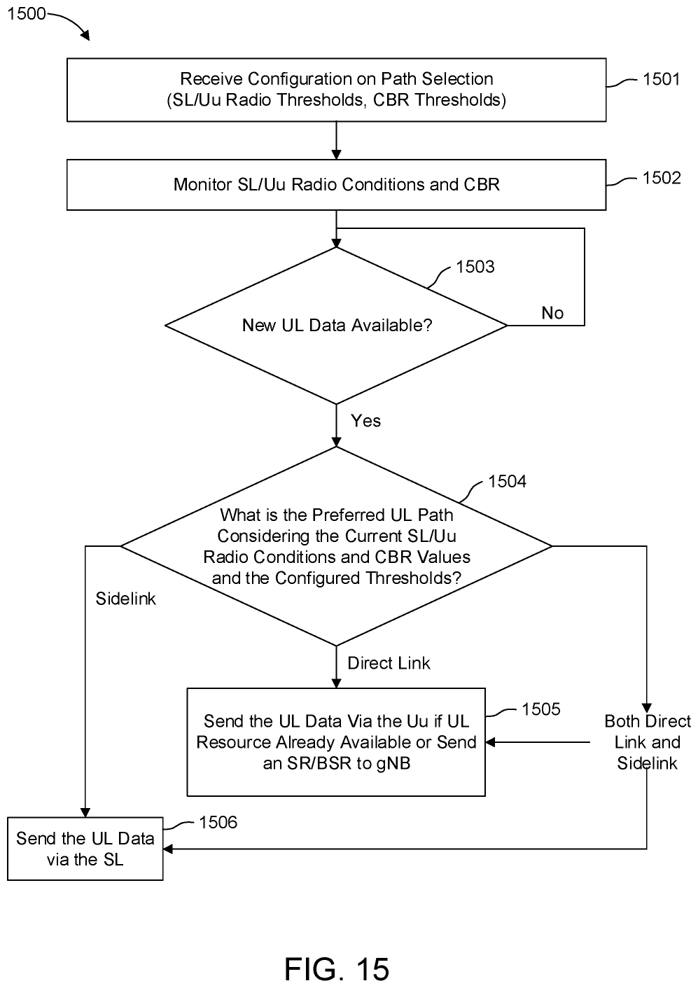

FIG. 15 is a flow diagram illustrating a procedure for path selection 1500, according to an embodiment. In some embodiments, one or more paths for sending UL data may be determined. A WTRU, configured to operate as a remote WTRU for connecting to a base station via a relay WTRU, may perform one or more of the following. At 1501, the WTRU may receive configuration information regarding how to transmit UL data that is destined to the base station. The configuration information may contain conditions and/or thresholds. In some embodiments, the configuration information includes network conditions. In some embodiments, the network conditions may include sidelink or/direct link radio signal levels (e.g., Reference Signal Receive Power (RSRP), Reference Signal Receive Quality (RSRQ), and/or Reference Signal to Noise Indicator (RSNI) thresholds), relative offsets between serving and neighbor sidelink/direct radio link signal levels, and/or load/congestion levels (e.g., sidelink CBR/CR thresholds, a direct link load reported by the network to the WTRU, a load of the backhaul link reported from the relay WTRU to the WTRU, etc.).

Additionally, or alternatively, the configuration information may include WTRU/data conditions. In some embodiments, the WTRU/data conditions may include priority of CP data (e.g., SRB1, SRB2, etc.); priority/QoS of UP data (e.g., GBR bearers, URLLC bearers, etc.); a size of pending UL data; and/or a type of UL CP data (e.g., WTRU originated CP signaling, response to DL CP signaling, measurement reports, failure reports, etc.).

In some embodiments, the configuration information may indicate an association between the conditions and/or thresholds with the preferred path for sending UL data (e.g., via the direct link, the sidelink, both the direct link and sidelink, or two sidelinks).

At 1502, the WTRU may monitor the network conditions and/or the WTRU/data conditions, depending on the configuration information. In some embodiments, the WTRU may monitor the sidelink and direct link radio levels. Additionally, or alternatively, the WTRU may monitor the sidelink CBR/CR. At 1503, the WTRU may determine if there is new UL data available. If there is no new UL data available, the WTRU may continue monitoring. If there is new UL data available, the WTRU may compare the configured conditions with the current network and/or WTRU/data conditions (e.g., radio signal levels, load levels, priority/QoS of the data, etc.), and determine one or more preferred paths to send the UL CP data (e.g., direct path, sidelink path, both direct and sidelink paths, or two sidelink paths) at 1504. In some embodiments, the configured conditions may be associated with one or more thresholds. If it is determined that the preferred path is a sidelink path, the WTRU may send the UL data via the sidelink path at 1506. If it is determined that the preferred path is a direct path, the WTRU may send the UL data via the direct path if the UL resource is already available or may send an SR/SBR to gNB at 1505. If it is determined that the preferred paths are both a direct path and a sidelink path, then the WTRU may send the UL data via the direct path and sidelink path at 1506. In some embodiments, it may be determined that the preferred paths are two sidelinks, in which case the WTRU may send the UL data via the two sidelink paths (not shown).

In some embodiments, it may be determined whether to or choose one path for sending UL data or duplicating a path. A WTRU, configured to operate as a remote WTRU for connecting to a base station (gNB) via a relay WTRU, configured with conditions/thresholds to determine the path(s) for the transmission of UL data, may upon determining that both paths can be used for UL transmission, do one or more of the following. In some embodiments, the WTRU may choose one of the paths (e.g., randomly, based on previous/recent usage statistics on each link, etc.) and transmit the data via that path only. In some embodiments, the WTRU may send data on both links (e.g., use available grants (if any) over the sidelink or direct link, send scheduling request/BSR to the base station if no resources available on the direct link, autonomously select resources from preconfigured sidelink pool of resources based on channel sensing mechanisms, etc.).

In some embodiments, if the resources over one link have not become available after the data has been sent over the other link for a certain (e.g., pre-configured) time, the WTRU may stop/refrain from sending the data over that one link.

In some embodiments, if the resources over one link have not become available by the time the data has been sent over the other link, and lower layer acknowledgement has been received regarding that transmission (either fully or partially indicating the reception of the data), the WTRU may stop/refrain from sending the data over that one link.

In some embodiments, the WTRU may send data on one of the links and if no lower layer acknowledgements have been received regarding this sent data after a certain (e.g., pre-configured) time, the WTRU may send the data over the other link.

In some embodiments, the WTRU may send data on one of the links and if indication are received from the other link that the transmission has failed (e.g., a certain number of negative acknowledgement (NACK) received, radio link failure detected, etc.), the WTRU may send the data over the other link.

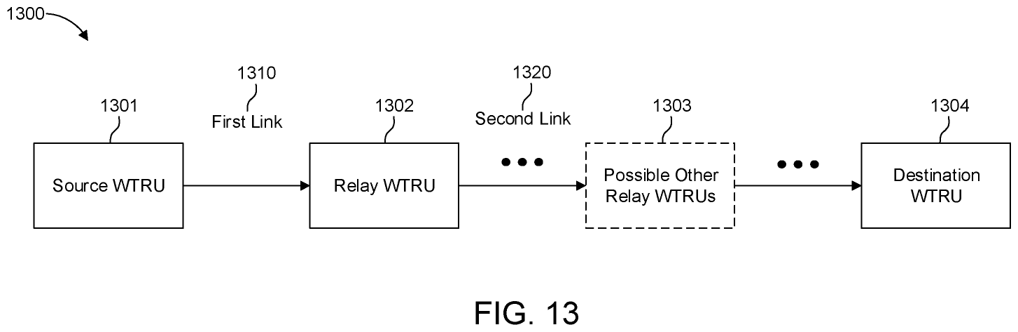

FIG. 13 is a diagram illustrating a scenario 1300 in which a relay WTRU 1302 may be used as a WTRU to WTRU relay, according to an embodiment. The first link 1310 may correspond to the link between a source WTRU 1301 and a relay WTRU 1302. The second link may 1320 refer to a link between the relay WTRU 1302 and one or more of the destination WTRU 1304 or the next hop in a multi-hop WTRU to WTRU (i.e., relay WTRU(s) 1303).

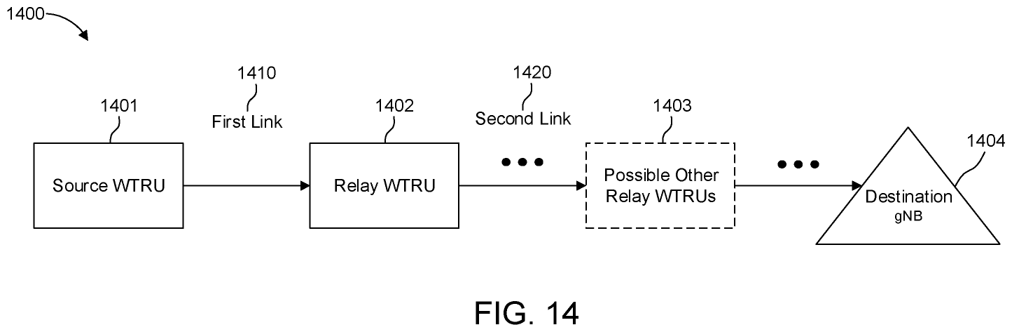

FIG. 14 shows an example scenario 1400 in which a relay WTRU 1420 may be used as a WTRU to NW relay. The first link 1410 may correspond to the link between a source WTRU 1402 and a relay WTRU 1402. The second link 1420 may refer to a link between the relay WTRU 1402 and one or more of the destination base station (gNB) 1404 or the next hop in a multi-hop WTRU to NW (i.e., relay WTRU(s) 1402).

Without loss of generality, a source WTRU may also refer to the relay WTRU being served by another relay along the link to a destination.

Without loss of generality, the relay WTRU may be an integrated access and backhaul (IAB) node, which may include two or more parts: a distributed unit (DU) of the base station that is connected to the remote/source WTRU, and a mobile termination (MT) part that is used to connected to another relay WTRU (e.g., in the case of a multi-hop scenario) or a donor DU of the base station (e.g., in the case of a one-hop scenario).

Without loss of generality, the relay WTRU may be assumed to be the serving relay WTRU that is currently serving the remote WTRU or a neighbor relay WTRU. The terms link and path may be used interchangeably.

All of the embodiments described herein may be equally applicable to CP as well as UP signaling.

In some embodiments, a WTRU may be configured to consider radio conditions of the sidelink and the direct link to decide UL signaling.

In some embodiments, the remote WTRU may be provided with thresholds/conditions related to the direct link radio conditions between the remote WTRU and the base station and/or the sidelink radio conditions between the remote WTRU and the relay WTRU. The WTRU may use the thresholds/conditions to determine how to send UL data.

In some embodiments, the thresholds/conditions may be absolute thresholds related to the direct link or/and the sidelink. For example, the WTRU may choose the direct link if the direct link signal level (e.g., RSRP) is above a certain threshold (e.g., x dbm). The WTRU may choose the direct link if the sidelink signal level (e.g., RSRP) is above a certain threshold (e.g., y dbm). The WTRU may choose both links if the direct signal level (e.g., RSRP) is below a certain threshold (e.g., x1 dbm) and the sidelink signal level (e.g., RSRP) is below another threshold (e.g., y1 dbm)

In some embodiments, the thresholds/conditions may be relative thresholds between the direct link and the sidelink. For example, the WTRU may choose the direct link if the direct link signal level (e.g., RSRP) is above a certain threshold (e.g., x dbm). The WTRU may choose the direct link if the sidelink signal level (e.g., RSRP) is above a certain threshold (e.g., y dbm). The WTRU may choose both links if the direct signal level (e.g., RSRP) is below a certain threshold (e.g., x1 dbm) and the sidelink signal level (e.g., RSRP) is below another threshold (e.g., y1 dbm).

In some embodiments, the thresholds/conditions may be related to the direct link's radio condition (e.g., RSRP/RSRQ/RSNI threshold). For example, the WTRU may choose the direct link for UL data if the direct link's RSRP is above x dBm, and the WTRU will choose the sidelink if the direct link's RSRP is below y dBm (where y<=x).

In some embodiments, the thresholds/conditions may be related to the sidelink's radio condition (e.g., RSRP/RSRQ/RSNI threshold). For example, the WTRU may choose the sidelink for UL data if the sidelink's RSRP is above x dBm, and the WTRU may choose the direct link if the sidelink's RSRP is below y dBm (where y<=x).

In some embodiments, the additional information may include a condition related to the direct and sidelinks' radio conditions (e.g., RSRP/RSRQ/RSNI thresholds). This may be based on absolute thresholds, relative thresholds or a combination. For example, in the case of an absolute threshold, the WTRU may use sidelink if the RSRP of the sidelink is greater than x dBm and the RSRP of the direct link is less than y dBm. The WTRU may use both links if the RSRP of the sidelink is below x dBm and the RSRP of the direct link is below y dBm. In the case of a relative threshold, the WTRU may use sidelink if the RSRP of the sidelink is zdBs better than the RSRP of the direct link. In the case of a combination of thresholds, the WTRU may use both links if the RSRP of the direct link is below x dBm, and the sidelink is no more than z dBs below the direct link.

In some embodiments, a time to trigger (TTT) may be specified, which indicates for how long a condition must be held for the WTRU to consider the condition as fulfilled.

In some embodiments, a WTRU may be configured to determine UL radio link levels in different ways. For instance, in some embodiments, the signal level thresholds for the direct link or sidelink (e.g., RSRP/RSRQ/RSNI) that are used to decide by the WTRU to determine how to transmit UL data may refer to the downlink signal levels as measured by the remote WTRU.

In some embodiments, the signal levels thresholds may refer to the UL signal levels.

In some embodiments, the remote WTRU may receive information about the UL signal level from the base station (e.g., for the direct link) and the relay WTRU (e.g., for the sidelink). To enable this, the network (base station or relay WTRU) may configure the WTRU with uplink reference signals (e.g., SRS) configuration, and based on this, the WTRU may send the uplink reference signals that the network (base station or relay WTRU) will use to perform UL measurements. The UL measurements may be sent to the WTRU either periodically or based on events. For example, the network may report to the WTRU when the UL signal level is below or above a certain threshold, when the signal level has changed by a certain absolute level or relative level (e.g., as a percentage of the previous level or a specified level)

In some embodiments, the remote WTRU may determine the UL signal levels based on the DL signal levels that it measures (e.g., using a mapping function/table). That is, the WTRU may be able to estimate the UL signal based on the current DL signals.

In some embodiments, the network may provide the WTRU with the mapping function/table.

In some embodiments, the WTRU may build the mapping table between the UL and DL signals. For example, there may be a training period wherein the WTRU receives frequent periodic UL measurements from the network and may store the UL measurement results along with the DL signal level it has performed at that time. After a considerable amount of data has been gathered (e.g., based on convergence of the mapping table entries), the WTRU may inform the network and stop the transmission of the UL SRS and the network also stopping the UL measurement reports accordingly.

In some embodiments, the WTRU may consider the location (e.g., GPS coordinates) of the WTRU in addition to or instead of the measured signal levels. For example, the mapping table may be just location information mapped with estimated UL signal. In some embodiments, the mapping table may be considered a 3D table where for each location (or range of location) there could be a DL signal to UL signal mapping.

In some embodiments, a WTRU may be configured to consider both the sidelink towards the relay WTRU and backhaul link between the relay WTRU and the base station.

In some embodiments, a WTRU may consider the signal level towards the sidelink and the signal level of the Uu link between the relay WTRU and the base station (i.e., backhaul link). The signal level of the backhaul link may be determined by the relay WTRU and sent to the remote WTRU. The relay WTRU, in order to determine the UL signal level towards the base station, may use similar mechanisms as discussed above by the remote WTRU to determine the UL signal level between the remote WTRU and the base station (e.g., UL measurement reports of the backhaul link sent by the base station based on the UL SRS it is receiving from the relay WTRU, UL signal level determined based on mapping table/function with DL signal level and/or location, etc.).

In some embodiments, the relay WTRU may send the UL measurements concerning the backhaul link that the WTRU is receiving from the base station and the UL measurements of the sidelink separately to the remote WTRU.

In some embodiments, the relay WTRU may send both the UL measurements concerning the backhaul link and the UL measurements of the sidelink together to the remote WTRU.

In some embodiments, the base station may send the UL measurements of the backhaul link directly towards the remote WTRU in addition to or instead of sending it to the relay WTRU.

In some embodiments, the remote WTRU may consider the UL signal level towards the sidelink to be the minimum of the determined sidelink UL signal level and the UL signal level of the backhaul link that it has received from the relay WTRU or the base station.

In some embodiments, the remote WTRU may consider the UL signal level towards the sidelink to be the maximum of the determined sidelink UL signal level and the UL signal level of the backhaul link that it has received from the relay WTRU or the base station.

In some embodiments, the remote WTRU may consider the UL signal level towards the sidelink to be the mean/average of the determined sidelink UL signal level and the UL signal level of the backhaul link that it has received from the relay WTRU or the base station.

In some embodiments, the relay WTRU or the base station may provide to the remote WTRU an offset/scaling value that is derived from the backhaul link UL measurements. The remote WTRU may downgrade/upgrade the sidelink signal level according to this value (either directly applying the offset or using some other value derived from this offset). One offset may be used for all types of measurement quantities (e.g., RSRP, RSRQ, etc.), or a different offset may be used for each type of measurement quantity. Additionally, or alternatively, even though only one offset is provided by the relay WTRU, there may be a different way of converting this offset to different measurement quantities (e.g., f1 (offset)=offset_RSRP, f2(offset)=offset_RSRQ, etc.).

In some embodiments, a WTRU may be configured to consider load conditions to decide UL data. In some embodiments, the remote WTRU may be provided with thresholds/conditions related to the congestion of the sidelink (e.g., CBR, CR). For example, in some embodiments, a WTRU may choose the direct link if the CBR/CR on the sidelink is above a certain threshold (e.g., x %). In some embodiments, a WTRU may choose the sidelink if the CBR/CR on the sidelink is below a certain threshold (e.g., y %).

In some embodiments, the remote WTRU may also be provided with thresholds/conditions related to the congestion/occupancy of the backhaul link. The remote WTRU may get the current congestion level of the backhaul link from the relay WTRU (e.g., periodically, when the congestion level falls below a certain level, when the congestion level is above a certain level, when the congestion level changes up/down by a certain percentage, etc.).

The thresholds related to the backhaul congestion may be used independently or in conjunction. For example, in some embodiments, a WTRU may choose the direct link if the backhaul congestion is above a certain level, regardless of the CBR/CR on the sidelink. In some embodiments, a WTRU may choose the sidelink if the CBR/CR is below x % and the congestion of the backhaul link is below y %. In some embodiments, a WTRU may consider the sidelink congestion to be the minimum of the sidelink's CBR/CR and the congestion of the backhaul link, and then compare it with the threshold/conditions specified for the sidelink's CBR/CR. In some embodiments, a WTRU may consider the sidelink congestion to be the maximum of the sidelink's CBR/CR and the congestion of the backhaul link, and then compare it with the threshold/conditions specified for the sidelink's CBR/CR. In some embodiments, a WTRU may consider the sidelink congestion to be the mean/average of the sidelink's CBR/CR and the congestion of the backhaul link, and then compare it with the threshold/conditions specified for the sidelink's CBR/CR.

In some embodiments, a WTRU may be configured to consider type of the data, for example, to decide UL data. In some embodiments, the remote WTRU may be provided with conditions related to the type of the UL data to be sent. In some embodiments, the remote WTRU may be configured to use the direct link for all CP data as long as the WTRU is in coverage.

In some embodiments, the remote WTRU may be configured to use the direct link for certain types of CP signaling and the sidelink for other types of CP signaling. For example, in some embodiments the remote WTRU may be configured with a priority of CP data (e.g., SRB1 to be sent via direct link, SRB2 via sidelink), WTRU triggered UL messages (e.g., measurement reports) sent via direct link, responses to DL messages (e.g., RRC complete messages) sent via sidelink, and/or connection control messages (e.g., RRC Setup, RRC Resume, RRC re-establishment, etc.) sent via the sidelink only, the direct link only, or both the sidelink and the direct link.

In some embodiments, the remote WTRU may be configured to use the direct link for certain type of UP UL data and the sidelink for other types of UP UL data. For example, the other types of data may comprise: data belonging to bearers of certain QoS (e.g., low latency) sent via direct link only, as long as the WTRU is in coverage of the base station; data belonging to bearers of certain QoS (e.g., GBR) sent via the relayed link; data belonging to bearers of certain QoS (e.g., best effort) sent via either link; data belonging to bearers of high latency and high reliability (e.g., URLLC) sent on both links; or packets with a size greater than a certain amount sent only via the sidelink.

In some embodiments, a WTRU may be configured to consider the level of retransmissions. For example, in some embodiments, the remote WTRU may be provided with conditions related to the level of retransmissions (e.g., at HARQ level, RLC level, etc.) on the sidelink or direct link to determine on how to transmit UL data. In some embodiments, a WTRU may switch the UL transmission towards the sidelink if the level of retransmissions on the direct link is above a certain level. In some embodiments, a WTRU may switch the UL transmission towards the direct link if the level of retransmissions on the sidelink is above a certain level. In some embodiments, a WTRU may use both links if the level of retransmission on the sidelink is above a certain level and the level of retransmissions on the direct link is above another level.

The embodiments described above may be combined in different ways. For example, a WTRU may be configured to use the sidelink for bearers of certain type (e.g., specific QoS level) only if the signal level on the sidelink (e.g., RSRP) is above a certain threshold and the sidelink CBR is below another threshold.

In addition to the combination of the thresholds, some thresholds may influence how the other metrics related to the other thresholds are measured/evaluated. For example, in some embodiments, a WTRU may be configured to send more frequent UL reference signals (e.g., SRS) that will be used to determine the UL signal levels at the base station, which is then sent to the WTRU, if the CBR on the sidelink rises above a certain level.

Embodiments in which both links may be used are described herein. As described above, the WTRU may be configured to use both links under certain conditions.

In some embodiments, when the conditions are fulfilled to use both links, the WTRU may send the data on one of the links. For example, in some embodiments, a WTRU may randomly choose the direct link or the sidelink to be used. In some embodiments, a WTRU may keep track of how much data it is sending via the direct link and the sidelink and may try to balance the two (e.g., the WTRU may try to send data via the sidelink if it has recently sent more data via the direct link).

In some embodiments, when conditions are fulfilled to use both links, the WTRU may duplicate the data on both links. For example, a WTRU may send a scheduling request/BSR to both links, and may send the data on both links when the grant becomes available.

In some embodiments, when the WTRU has determined that data has to be duplicated over both links, if the UL resources on one link arrives considerably later than the other, the WTRU may refrain from sending the data over the link that provided the grant later. Here, “considerably later” may refer to a certain configurable time duration (e.g., time duration in ms or frame/slot numbers), or may refer to the scenario in which the WTRU has already received acknowledgement (e.g., HARQ level) that indicates that the data has been properly received via the first link or a certain percentage of the data/packet has been received.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

1. A method performed by a Wireless Transmit/Receive Unit (WTRU), the method comprising:
receiving configuration information regarding path selection, the configuration information including configured parameters associated with at least one of network conditions or WTRU conditions;
determining a first path and a second path for transmission of available uplink (UL) data based on the configuration information and the current conditions;
receiving one or more conditions for duplication; and
transmitting the UL data on the first path, and
on a condition that the one or more conditions for duplication are fulfilled, transmitting the UL data on the second path.

2. The method of claim 1, wherein the configuration information includes associations between the configured parameters and one or more direct paths and one or more sidelink paths.

3. The method of claim 2, wherein the first path and the second path for transmission comprise a direct path, a sidelink path, a direct path and a sidelink path, or two sidelink paths.

4. (canceled)

5. The method of claim 1, wherein one or more of the configured parameters are associated with WTRU conditions and include one or more of a buffer level or a bearer type.

6. The method of claim 1, wherein the configured parameters include one or more thresholds for user plane (UP) data transmissions and one or more thresholds for control plane (CP) data transmissions.

7. The method of claim 6, wherein the WTRU determines a first path for UP data transmissions and a second path for CP data transmissions.

8. (canceled)

9. The method of claim 1, further comprising, randomly selecting one of the first path or the second path, and transmitting the UL data on the randomly selected path.

10. (canceled)

11. (canceled)

12. The method of claim 1, wherein the one or more conditions for duplication comprise at least one of time differences between UL resource availability on the first path and the second path or reception of a negative acknowledgement (NACK) on the first path.

13. A Wireless Transmit/Receive Unit (WTRU) comprising:
a receiver configured to receive configuration information regarding path selection, the configuration information including configured parameters associated with at least one of network conditions or WTRU conditions;
a processor and the receiver configured to:
determine a first path and a second path for transmission based on the configuration information and current conditions
receive one or more conditions for duplication; and
a transmitter and the processor configured to transmit the UL data on the first path, and
on a condition that the one or more conditions for duplication are fulfilled, transmit the UL data on the second path.

14. The WTRU of claim 13, wherein the configuration information includes associations between the configured parameters and one or more direct paths and one or more sidelink paths.

15. The WTRU of claim 14, wherein the first path and the second path for transmission comprise a direct path, a sidelink path, a direct path and a sidelink path, or two sidelink paths.

16. The WTRU of claim 13, wherein one or more of the configured parameters are associated with network conditions and include one or more of a radio threshold, a signal quality threshold, or a channel busy ratio/channel occupancy ratio (CBR/CR) threshold.

17. The WTRU of claim 13, wherein one or more of the configured parameters are associated with WTRU conditions and include one or more of a buffer level or a bearer type.

18. (canceled)

19. (canceled)

20. (canceled)
